(19) United States
(12) Patent Application Publication
(10) Pub. No.: US 2008/0250835 A1
(43) Pub. Date: Oct. 16, 2008

(54) Roll Hemming Method and Roll Hemming Apparatus

(75) Inventors: Eisaku Hasegawa, Tochigi-ken (JP); Akira Kodama, Tochigi-ken (JP); Hitoshi Saito, Tokyo (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 11/911,891

(22) PCT Filed: Dec. 21, 2005
(86) PCT No.: PCT/JP2005/023542

§ 371 Date: Oct. 18, 2007

(30) Foreign Application Priority Data
Apr. 27, 2005 (JP) 2005-129258

(51) Int. Cl. B21D 7/02; B23P 11/00

(52) U.S. Cl. 72/220; 29/243.58

(57) ABSTRACT

A roll hemming apparatus for bending the flange of an outer panel vertically extended from a bent part of the outer panel to an inner side of the outer panel includes a robot and a working tool fitted to a tip of the robot. The working tool includes a first roller supporting the bent part and a second roller pressing the part of the flange positioned near the bent part supported by the first roller, and is integrally moved along the bent part. The orientation and the attitude of the second roller is set by first to fourth cylinders.

### TECHNICAL FIELD

The present invention relates to a roll hemming method and a roll hemming apparatus for bending a flange as an erected edge of a panel inwardly of the panel.

### BACKGROUND ART

Automobile hoods, trunks, doors, and wheel houses have edges hemmed by bending a flange as a standing edge of a panel inwardly of the panel. One hemming process is known as a roll hemming process for positioning and holding a panel on a die and pressing a roller against a flange on an end of the panel to bend the flange. According to the roll hemming process, since the flange is bent by a large angle, the flange is hemmed through a plurality of stages including a pre-bending stage (or a prehemming stage) and a finishing stage (or a main hemming stage) to achieve desired bending accuracy.

There have been proposed roll hemming processes including a process of rolling a roller along a guide surface of a die for making a bent flange surface round (see, for example, Japanese Patent Publication No. 7-90299) and a process of continuously pre-bending and finishing a flange with a pre-bending roller and a finishing roller that are disposed side by side (see, for example, Japanese Laid-Open Patent Publication No. 2002-35865).

An apparatus for clamping a flange of a panel with a pair of rollers to hem the flange (see, for example, Japanese Laid-Open Patent Publication No. 7-060370) and an apparatus for performing a plurality of hemming processes with a support roller, a presser roller, a flange raising roller, a pre-bending roller, a hemming roller, and a panel support mechanism (see, for example, Japanese Laid-Open Patent Publication No. 8-164433 (FIG. 5)) have also been proposed.

The conventional roll hemming process necessarily requires dies for holding and positioning a panel as machining means. However, the dies are expensive and it takes many days to manufacture. Since dedicated dies need to be used for respective regions to be machined, corresponding hemming apparatus are dedicated for the respective regions to be machined, are hence poor in versatility, and need a large installation space. Furthermore, depending on the regions to be machined, the dies are large in size and are awkward to store and manage.

Modern automobiles are desired to be developed in a short period of time and also to be produced in many types at the same time. It is important to take into account how to produce and operate roll hemming dies for increasing the efficiency with which to develop and produce automobiles.

According to Japanese Laid-Open Patent Publication No. 7-060370, a flange is bent by a plurality of rollers. However, if the flange is bent inadvertently by the rollers, then as shown in FIG. 18, stresses 2 (shown crosshatched) are produced in a considerably wide range inwardly from a bent portion 1. If the flange is then hemmed, the portion where the stresses 2 are produced is deformed. When the pressure is removed after the flange is hemmed, a hemmed portion 4 is lifted off a lower roller 5 as indicated by the two-dot-and-dash lines 3. The flange may be bent inwardly of an expected bent portion, resulting in a reduction in the dimensional accuracy of the panel. In other words, the distance 7 by which the hemmed portion is displaced from an end face of an original flange 6 and the distance 8 by which the hemmed portion 4 is lifted off the roller 5 increase. Though this phenomenon occurs not only the rollers are used, but also dies are used, it is more likely to happen in the roll hemming process as the pressure is lower than when a press is used.

For causing stresses to concentrate on the bent portion, a presser roller may be applied to a flange inwardly thereof as shown in FIG. 5 of Japanese Laid-Open Patent Publication No. 8-164433. In the main hemming stage, a complex mechanism is required for retracting the presser roller and needs a wide space for retracting the presser roller therein. Depending on the shape of the panel to be machined, the presser roller may interfere with an upper convex portion of the panel. A presser roller disclosed in Japanese Laid-Open Patent Publication No. 2002-35865 is used to raise the flange, but not used to further bend the formed flange inwardly, and hence is unable to cause stresses to concentrate on the bent portion.

If a bearing roller and a bending roller are used to perform the roll hemming process, then the bearing roller operates as a conventional lower die. Since stresses are produced in a considerably wide range in the panel, the bearing roller needs to be of an inwardly elongate shape accordingly. If the bearing roller is too long, however, it may possibly interfere with a lower convex portion of the panel depending on the shape of the panel, and hence is poor in versatility. Conversely, if the bearing roller is too short, then it improves in versatility, but fails to appropriately bear stresses in a wide range. The bearing roller may leave a pressing mark on the lower surface of the panel along the path of an end of the bearing roller as it rolls, resulting in degradation in the appearance of the panel.

### DISCLOSURE OF THE INVENTION

It is an object of the present invention to provide a roll hemming method and a roll hemming apparatus which are capable of performing a roll hemming process with increased hemming accuracy and high versatility without the need for dies.

According to the present invention, a roll hemming method of bending a flange as an erected edge of a panel, inwardly of the panel, comprises supporting an outer side of a bent portion of the flange with a first roller, pressing inwardly the flange near the bent portion supported by the first roller with a second roller, and bending the flange inwardly of the panel while moving the first roller and the second roller together along the bent portion.

The flange is bent when it is pressed by the second roller while its edge is being supported by the first roller. The flange is thus roll-hemmed without the need for dies. Since the roll hemming process is performed by moving the first roller and the second roller together along the edge, the roll hemming method is applicable to various regions to be machined and is of increased versatility.

The roll hemming method may comprise a first step of pressing the flange with an end surface of the second roller to bend the flange until the bent portion provides an acute angle, and a second step of changing the orientation and position of the second roller and further bending the flange with an outer circumferential surface of the second roller. Thus, regions which need to be bent by a large bending angle can be bent with high machining accuracy. The first roller and the second roller may be shared by the first step and the second step.

In the first step, a third roller coaxial with the second roller and smaller in diameter than the second roller may be used, and a top end of the flange may be pressed toward the bent portion with an outer circumferential surface of the third roller. Stresses applied to the panel are thus caused to concentrate on the bent portion to prevent unwanted regions from being unduly deformed. The flange is thus prevented from being lifted off and displaced, and is roll-hemmed with increased accuracy. As the first roller can be reduced in axial length, the first roller can move neatly along complex panels having complex flange shapes, and the roll hemming method is of increased versatility.

If the second roller and the third roller are coaxial with each other, then they may be formed integrally with each other in a simple structure.

According to the present invention, a roll hemming method of bending a flange as an erected edge of a panel, inwardly of the panel, comprises supporting an outer side of a bent portion of the flange with a first roller, pressing an outer side surface of the flange with a second roller, pressing a top end of the flange toward the bent portion with a third roller, and bending the flange inwardly of the panel to provide an acute angle while rotating the first roller, the second roller, and the third roller.

When the top end of the flange is pressed toward the bent portion in roll-hemming the flange with the third roller, stresses applied to the panel are caused to concentrate on the bent portion to prevent unwanted regions from being unduly deformed. The flange is thus prevented from being lifted off and displaced. Since the first roller as a bearing roller may support a region where stresses concentrate, the first roller may be reduced in axial length. Therefore, the first roller can move better along the flange even if the flange is of a complex curved shape along the direction in which it extends. Even if the panel has a protrusion, the first roller is held out of interference with the protrusion, and the roll hemming method is of increased versatility.

If the outer side surface of the flange is pressed with an outer circumferential surface of the second roller, and the top end of the flange is pressed toward the bent portion with an outer circumferential surface of the third roller, then both the second roller and the third roller are held in contact with the flange in a sufficiently small area, so that the region to be machined is kept in the contact area. As the second roller and the third roller do not slide, but roll on the flange, they can move neatly depending on the shape of the flange along the direction in which it extends, and the roll hemming method is of increased versatility.

According to the present invention, a roll hemming apparatus for bending a flange as an erected edge of a panel, inwardly of the panel, comprises a first roller for supporting an outer side of a bent portion of the flange, a second roller for pressing inwardly a portion of the flange near the bent portion supported by the first roller, and a moving unit for moving the first roller and the second roller together along the bent portion.

The flange is bent when it is pressed by the second roller while its edge is being supported by the first roller. The flange is thus roll-hemmed without the need for dies. The roll hemming apparatus is applicable to various regions to be machined simply by setting moving operation of the moving unit, can be developed within a highly short period of time, and is of increased versatility.

The roll hemming apparatus may comprise a third roller for pressing a top end of the flange toward the bent portion in at least one step. The third roller is able to cause stresses applied to the panel to concentrate on the bent portion to prevent unwanted regions from being unduly deformed. The flange is thus prevented from being lifted off and displaced, and is roll-hemmed with increased accuracy. As the first roller can be reduced in axial length, the first roller can move neatly along complex panels having complex flange shapes, and the roll hemming apparatus is of increased versatility.

The roll hemming apparatus may comprise a retracting mechanism for changing the orientation of the third roller about an axis of the second roller or an axis parallel to the axis. When the third roller is retracted, it moves along a circle having a small radius, and can quickly and simply be retracted out of interference with protrusions of the panel and other structures. The retracting mechanism is simple in structure.

### BRIEF DESCRIPTION OF THE DRAWINGS

FIG. 1 is a block diagram of a roll hemming apparatus according to an embodiment of the present invention;

FIG. 2 is a side elevational view of a workpiece and a machining tool while a first roll hemming process is being performed, the view also showing an arrangement of a tool controller;

FIG. 3 is a flowchart of a sequence of a roll hemming method according to the embodiment of the present invention;

FIG. 4 is a cross-sectional view showing a bent shape of a flange roll-hemmed in the first roll hemming process by the roll hemming apparatus according to the embodiment;

FIG. 5 is a perspective view, partly in cross section, of the workpiece and the machining tool while the first roll hemming process is being performed;

FIG. 6 is a side elevational view of the workpiece and the machining tool while a second roll hemming process is being performed, the view also showing the arrangement of the tool controller;

FIG. 7 is a perspective view, partly in cross section, of the workpiece and the machining tool while the second roll hemming process is being performed;

FIG. 8 is a side elevational view of a machining tool according to a first modification;

FIG. 9 is a perspective view, partly in cross section, of the workpiece and the machining tool according to the first modification while the first roll hemming process is being performed;

FIG. 10 is a perspective view, partly in cross section, of the machining tool according to the first modification while the first roll hemming process is being performed;

FIG. 11 is a side elevational view of the machining tool according to the first modification while the second roll hemming process is being performed;

FIG. 12 is a perspective view of a modified mechanism for retracting a third roller and a panel near the modified mechanism;

FIG. 13 is a side elevational view of a machining tool according to a second modification;

FIG. 14 is a side elevational view showing the workpiece and a machining tool according to a third modification while a third roll hemming process is being performed, the view also showing the arrangement of the tool controller;

FIG. 15 is a perspective view, partly in cross section, of the workpiece and machining tool according to the third modification while the second roll hemming process is being performed;

FIG. 16 is a side elevational view of the workpiece and a machining tool according to a fourth modification while the first roll hemming process is being performed;

FIG. 17 is a view showing locations of a motor vehicle where a roll hemming process is performed; and

FIG. 18 is a cross-sectional view showing a bent shape of a flange hemmed by a conventional apparatus.

### BEST MODE FOR CARRYING OUT THE INVENTION

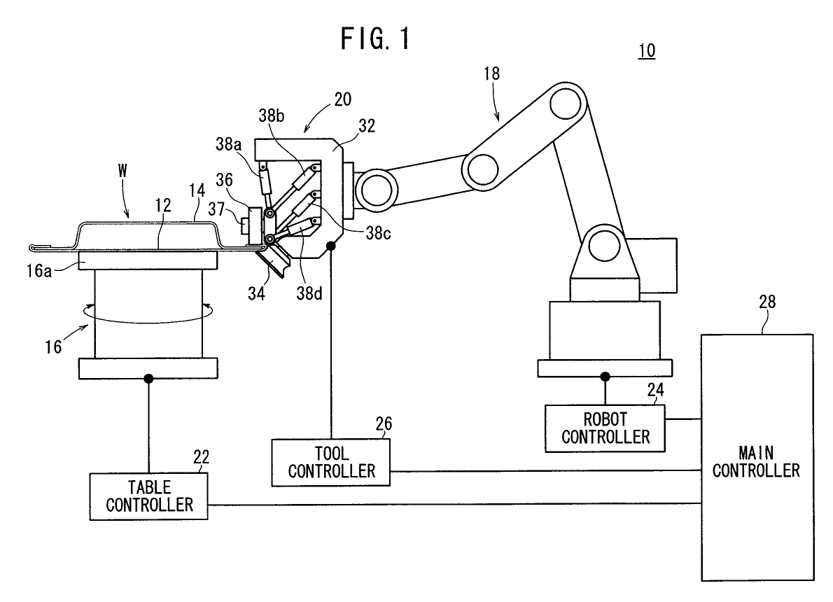

Roll hemming methods and roll hemming apparatus according to embodiments of the present invention will be described below with reference to FIGS. 1 through 17 of the accompanying drawings.

As shown in FIG. 1, a roll hemming apparatus 10 according to an embodiment of the present invention is an apparatus for roll-hemming an edge of a workpiece W comprising an outer panel 12 and an inner panel 14, and includes a machining table (moving unit) 16 for supporting the workpiece W thereon, a robot (moving unit) 18, and a machining tool 20 mounted on a distal end of the robot 18. The workpiece W may be loaded onto and unloaded from the machining table 16 by a given automatic workpiece changer.

The machining table 16, the robot 18, and the machining tool 20 are controlled respectively by a table controller 22, a robot controller 24, and a tool controller 26. The table controller 22, the robot controller 24, and the tool controller 26 are synchronously controlled by a main controller 28.

The machining table 16 rotates the workpiece W horizontally under the control of the table controller 22, and operates an XYZ table 16a to move the workpiece W horizontally and vertically. The robot 18 is of the industrial articulate type, and is capable of moving the machining tool 20 to a desired posture at a desired position within an operable range. The robot 18 can be taught to learn certain patterns of movement while it is in actual operation, using a teaching pendant, not shown. The robot 18 may also be taught to learn certain patterns of movement while it is not in actual operation, according to an off-line process based on three-dimensional CAD (Computer-Aided Design).

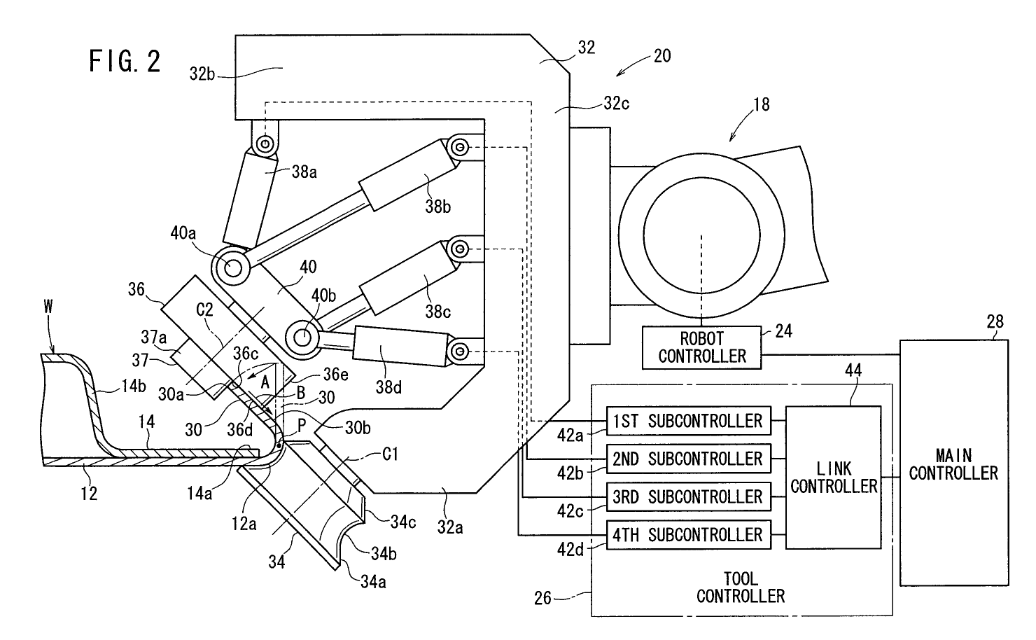

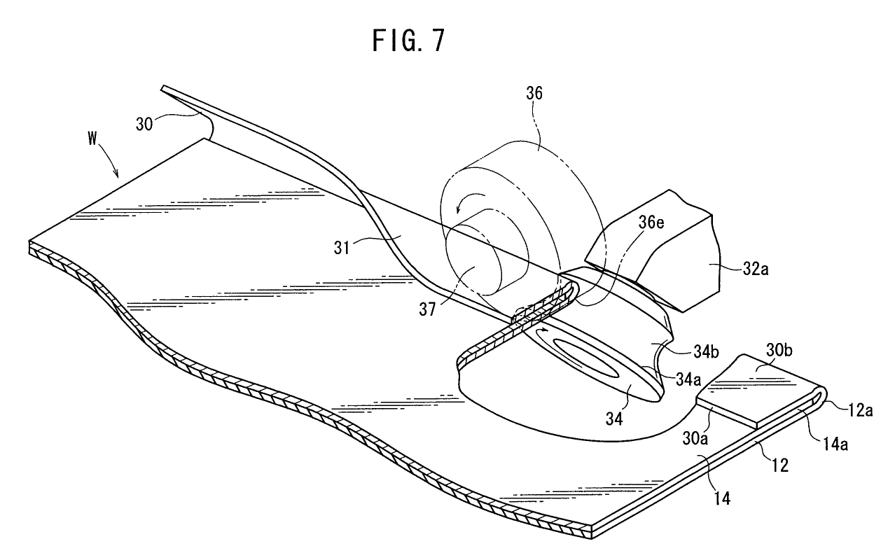

As shown in FIG. 2, the machining tool 20 is a tool for bending a flange 30 which is erected substantially at a right angle from a bent portion 12a of the outer panel 12, inwardly of the outer panel 12, and is capable of causing the flange 30 to grip an edge 14a of the inner panel 14, integrally combining the flange 30 and the edge 14a with each other (see FIG. 7). The workpiece W is provisionally fixed in position with the outer panel 12 in a lower position and the inner panel 14 in an upper position. The edge 14a of the inner panel 14 is disposed near and along the bent portion 12a of the outer panel 12. At this time, the flange 30 extends upwardly. The distance from the edge 14a to the flange 30 is sufficiently smaller than the height of the flange 30.

The machining tool 20 comprises an arch member 32, a first roller 34 for supporting the bent portion 12a, a second roller 36 for pressing an outer side surface 30b of the flange 30 near the bent portion 12a supported by the first roller 34, a third roller 37 for pressing a top end 30a of the flange 30, and a first cylinder 38a, a second cylinder 38b, a third cylinder 38c, and a fourth cylinder 38d which serve as a position setting assembly for changing the orientations and positions of the second roller 36 and the third roller 37. The arch member 32 is substantially in the shape of a U, and includes a first extension 32a, a second extension 32b, and a base member 32c interconnecting respective ends of the first extension 32a and the second extension 32b.

The first roller 34 is rotatably supported on a mounted distal end of the first extension 32a and is inclined about 45° outwardly to the mounted distal end of the first extension 32a with respect to the direction in which the first extension 32a extends. The first roller 34 has a first reduced-diameter portion 34a which is progressively smaller in diameter toward the proximal end thereof to the first extension 32a, an annular arcuate recess 34b blending continuously and smoothly into a smaller-diameter end of the first reduced-diameter portion 34a, and a second reduced-diameter portion 34c which is progressively smaller in diameter from the annular arcuate recess 34b toward the proximal end thereof. The first reduced-diameter portion 34a has an upper end surface which provides an edge lying substantially parallel to the direction in which the first extension 32a extends. The annular arcuate recess 34b comprises an arcuate recess having a cross section of about 90°.

The second roller 36 and the third roller 37 are rotatably supported on a bearing member 40 coaxially and integrally. The second roller 36 is disposed on the mounted proximal end of the roller assembly, and the third roller 37 is disposed on the distal end thereof. The second roller 36 is in the form of a cylinder whose height is smaller than the diameter thereof. The second roller 36 and the third roller 37 are of a simple structure in the form of an integral stepped cylinder. If necessary, the second roller 36 and the third roller 37 may be of such a structure that they are rotatable independently of each other. The third roller 37 has a diameter that is about one-half the diameter of the second roller 36 and an axial length which is equal to or greater than the thickness of the flange 30, and hence is sufficiently short. The diameter of the second roller 36 is about twice the height of the flange 30.

The bearing member 40 is in the form of a somewhat elongate block supporting on its opposite ends a first support shaft 40a and a second support shaft 40b, respectively, which extend perpendicularly to the direction of an axis C2 of the second roller 36. The first cylinder 38a and the second cylinder 38b have respective rods whose distal ends are angularly movably supported on the first support shaft 40a, and the third cylinder 38c and the fourth cylinder 38d have respective rods whose distal ends are angularly movably supported on the second support shaft 40b. The first cylinder 38a has a tube whose end is disposed near the distal end of the second extension 32b of the arch member 32, and the second cylinder 38b has a tube whose end is disposed near the other proximal end of the second extension 32b. The third cylinder 38c has a tube whose end is disposed on a substantially intermediate portion of the base member 32c, and the fourth cylinder 38d has a tube whose end is disposed near the proximal end of the first extension 32a.

The second roller 36 as it is rotatably supported on the bearing member 40 is moved by a link mechanism which is made up of the bearing member 40 and the first through fourth cylinders 38a through 38d, to change its orientation and position while the axes C1, C2 of the first and second rollers 34, 36 are being kept positioned on one plane.

The first through fourth cylinders 38a through 38d are controlled by a first subcontroller 42a, a second subcontroller 42b, a third subcontroller 42c, and a fourth subcontroller 42d, respectively, of the tool controller 26 through a fluid pressure circuit (not shown). The first through fourth subcontrollers 42a through 42d are controlled integrally by a link controller 44 to set the orientation and position of the second roller 36 by referring to given sensor signals.

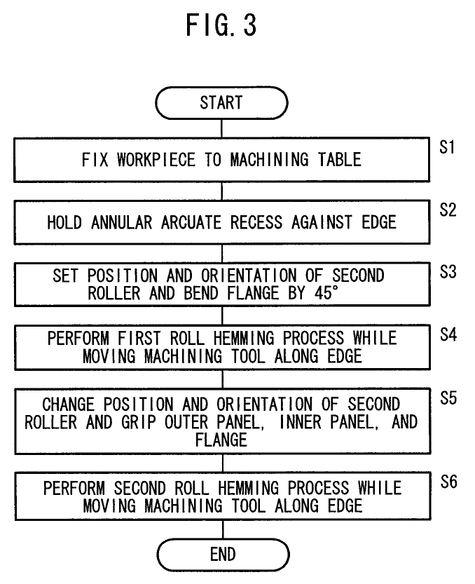

A process of roll-hemming the workpiece W with the roll hemming apparatus 10 thus constructed will be described below with reference to FIGS. 3 through 7. The process is performed in the order of step numbers indicated.

In step S1 shown in FIG. 3, the workpiece W is fixed to the machining table 16 with the outer panel 12 in a lower position and the inner panel 14 in an upper position. At this time, the flange 30 is erected upwardly.

In step S2, the robot controller 24 operates the robot 18 to move the machining tool 20. At this time, as shown in FIG. 2, the axis C1 of the first roller 34 is oriented obliquely downwardly at 45°, the upper end surface of the first reduced-diameter portion 34a is held against the lower surface of the outer panel 12, and the annular arcuate recess 34b fits over the bent portion 12a.

In step S3, the tool controller 26 operates the first through fourth cylinders 38a through 38d to set the position and orientation of the second roller 36. Specifically, the top end 30a of the flange 30 is held against a step corner 36c between the second roller 36 and the third roller 37, and an end surface 36d of the second roller 36 presses a side surface of the flange 30. The top end 30a of the flange 30 is positioned and pressed in the direction indicated by the arrow A, bending the flange 30 obliquely by 45° substantially about a bending base point P suitably. The axis C2 of the second and third rollers 36, 37 becomes substantially parallel to the axis C1, and the second roller 36 has a lower end positioned slightly above the first reduced-diameter portion 34a while being held in contact with an intermediate vertical portion of the flange 30.

At this time, the top end 30a of the flange 30 is pressed toward the bent portion 12a in the direction indicated by the arrow B by an outer circumferential surface 37a of the third roller 37. The force applied in the direction indicated by the arrow B is divided into a downward force and a laterally outward force. The downward force is borne by the first reduced-diameter portion 34a and the laterally outward force is borne by the annular arcuate recess 34b.

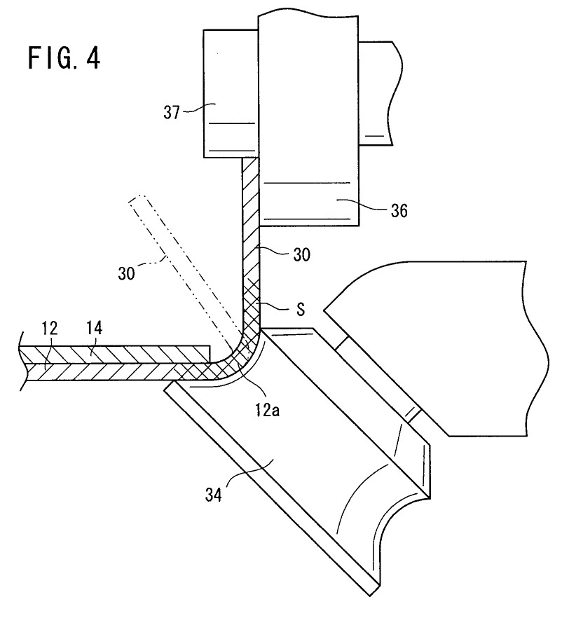

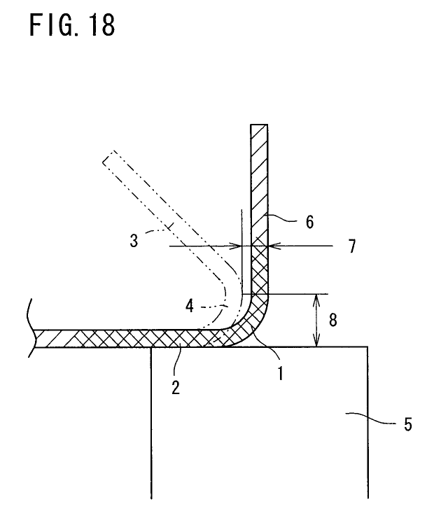

Specifically, as shown in FIG. 4, stresses S (shown crosshatched in FIG. 4) generated by the second roller 36 concentrate on the bent portion 12a, and the flange 30 is not deformed so as to be displaced inwardly. The flange 30 is bent as indicated by the two-dot-and-dash lines, and the bent portion 12a provides an appropriately round bent surface of a certain extent that is complementary in shape to the cross-sectional shape of the annular arcuate recess 34b. Even after the first roller 34 and the second roller 36 are spaced from the workpiece W, the outer panel 12 is prevented from being displaced and lifted from the annular arcuate recess 34b of the first roller 34, resulting in a high level of machining accuracy. It can be understood that the distance 7 by which the hemmed portion is displaced and the distance 8 by which the hemmed portion is lifted off are essentially eliminated compared with the bent shape of the flange that is roll-hemmed by the conventional apparatus shown in FIG. 18. In FIG. 4, the inner panel 14 is shown as being held against the outer panel 12. However, the second roller 36 is effective to prevent the outer panel 12 from being displaced and lifted off regardless of whether the inner panel 14 is present or not.

The pressing by the third roller 37 on the top end 30a of the flange 30 covers not only an active pressing provided by an actuator, but also a passive pressing provided by keeping the third roller 37 and the bent portion 12a spaced from each other by a fixed distance to positionally limit the top end 30a which tends to be lifted off.

The second roller 36 and the third roller 37 are not limited to the position and orientation shown in FIG. 2, but may be positioned and oriented appropriately in view of the thickness, material, etc. of the outer panel 12.

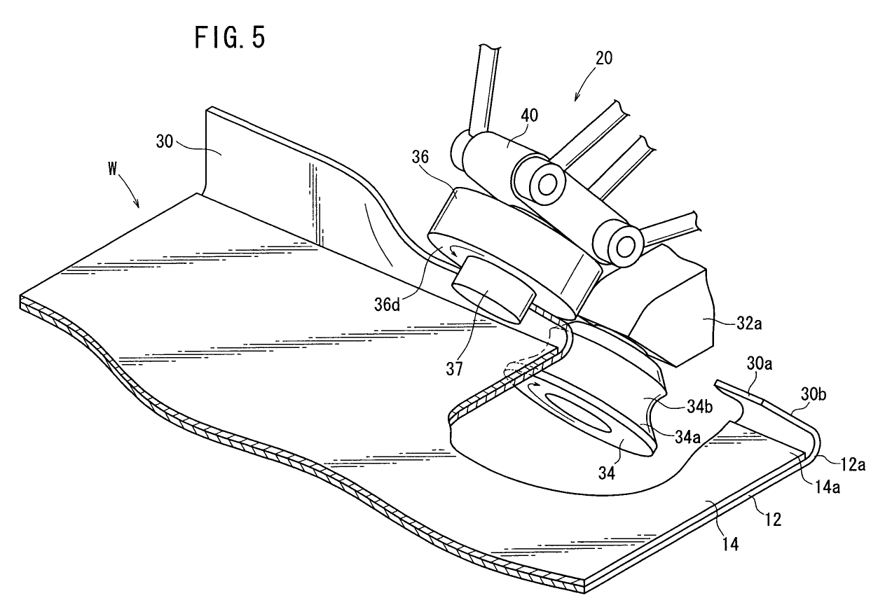

In step S4, the main controller 28 controls the table controller 22 and the robot controller 24 to control the machining table 16 and the robot 18, respectively, to perform a first roll hemming process (also referred to as a pre-hemming process). Specifically, as shown in FIGS. 2 and 5, while the second roller 36 is being kept in the set position and orientation, the machining tool 20 is moved along the bent portion 12a of the outer panel 12 to continuously roll-hem the flange 30 to bend it inwardly by 45°. The first roller 34 and the second roller 36 are rotated in mutually opposite directions and grip the bent portion 12a and the flange 30 to perform the first roll hemming process thereon. At this time, the bent portion 12a is bent into an appropriately round configuration complementary to the surface of the annular arcuate recess 34b of the first roller 34.

In step S4, the robot 18 and the machining table 16 operate synchronously in coordination to move the machining tool 20 fully along the bent portion 12a in the first roll hemming process. Since the robot 18 and the machining table 16 operate in coordination, the substantial amount of movement of the robot 18 is reduced for a shorter cycle time and a smaller operation space.

In FIG. 5 and FIGS. 7, 10, 12, and 15 mentioned later, the bent portion 12a is shown as extending straight for an easier understanding of the invention. However, the bent portion 12a may be of a two-dimensionally or three-dimensionally curved shape. If the bent portion 12a extends along a curved shape, then the machining tool 20 is moved such that the axes C1, C2 of the first roller 34 and the second roller 36 extend at a right angle to a line along the bent portion 12a and the annular arcuate recess 34b is suitably held against the bent portion 12a.

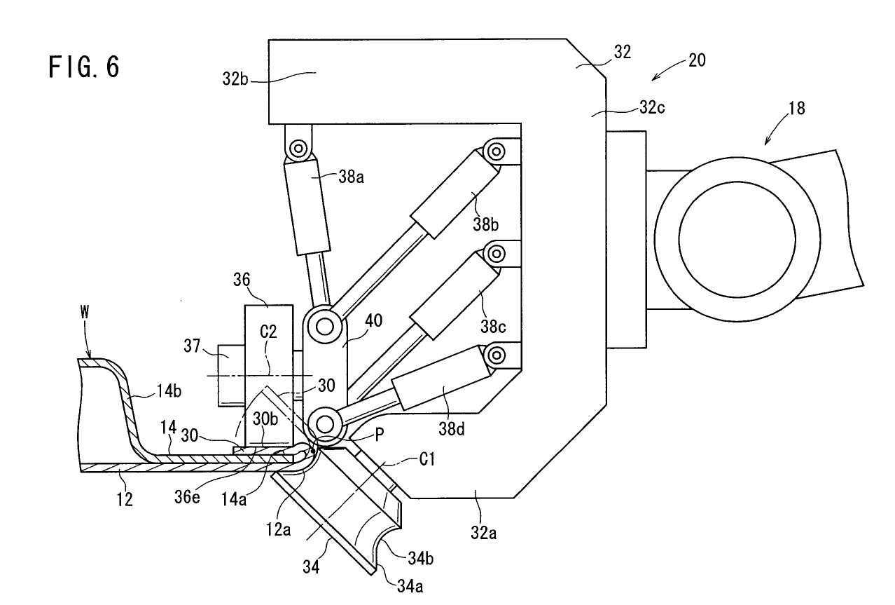

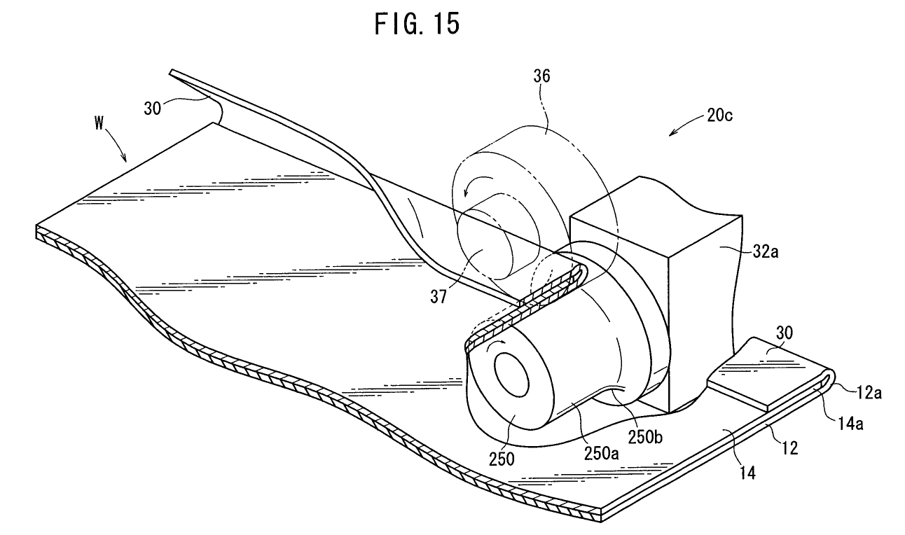

In step S5, the tool controller 26 operates the first through fourth cylinders 38a through 38d to change the position and orientation of the second roller 36. Specifically, as shown in FIGS. 6 and 7, the axis C2 of the second roller 36 is directed to extend parallel to the plane of the outer panel 12 and the direction in which the first extension 32a extends, causing the three layers, i.e., the outer panel 12, the edge 14a of the inner panel 14, and the flange 30, to be gripped between an outer circumferential surface 36e of the second roller 36 and the upper surface of the first reduced-diameter portion 34a. At this time, the second roller 36 is pressed downwardly by the first through fourth cylinders 38a through 38d to press the outer panel 12, the edge 14a of the inner panel 14, and the flange 30 into an integral structure. The end surface of the second roller 36 may be positioned slightly inwardly of the bent portion 12a of the outer panel 12 to bend the bent portion 12a into an appropriately round shape without compressing the bent portion 12a. In FIG. 7 (and FIG. 15), the second roller 36 is shown as being transparent by the two-dot-and-dash lines to make the machined region visible.

In step S5, since the axis C2 is horizontal and the third roller 37 is smaller in diameter than the second roller 36, the third roller 37 is retracted and kept on its own out of interference with the outer panel 12 and the inner panel 14. As the axial length of the third roller 37 is sufficiently small, the third roller 37 does not significantly project inwardly compared with the top end 30a of the flange 30. Therefore, even if the inner panel 14 has a protrusion 14b on its upper surface, the third roller 37 is prevented from interfering with the protrusion 14b. The roll hemming apparatus 10 is thus applicable to workpieces W of complex shapes and is of increased versatility.

In step S6, a second roll hemming process (also referred to as a main hemming process) is performed. Specifically, as with step S4, the robot 18 and the machining table 16 operate synchronously to move the machining tool 20 fully along the bent portion 12a to roll-hem the three layers, i.e., the outer panel 12, the edge 14a of the inner panel 14, and the flange 30, into an integral structure.

In the second roll hemming process, the third roller 37 is spaced from the top end 30a. However, since the bent portion 12a has already been bent by a sufficiently acute angle into an appropriate shape in the first roll hemming process, stresses concentrate on the bent portion 12a and the outer panel 12 is prevented from being lifted off.

With the roll hemming apparatus 10 and the roll hemming method according to the present embodiment, as described above, the first roller 34 and the second roller 36 are moved together along the bent portion 12a by the machining tool 20 and the robot 18 to bend the flange 30 inwardly. Inasmuch as the first roller 34 operates as the die in the conventional roll hemming process, no die is required. Since the roll hemming process is performed when the first roller 34 and the second roller 36 are moved together along the bent portion 12a, the roll hemming apparatus 10 is applicable to various regions to be machined and is of increased versatility. The machining tool 20 can be applied to new workpieces W without the need for dedicated dies fabricated heretofore for respective workpieces W, allowing products such as automobiles employing workpieces W to be developed in a short period of time. While the conventional dies are of complex shapes corresponding to workpieces W and need to be designed and produced over a long period of time, the first roller 34 and the second roller 36 are simple in shape and can be designed and produced in a short period of time.

Even if a plurality of types of workpieces W are to be placed on the machining table 16, the machining table 16 and the robot 18 may be operated based on separate teaching data to roll-hem those different workpieces W. The roll hemming apparatus 10 is thus suitable for manufacturing many types of products. The first roller 34 is much smaller than the conventional dies and is simple to store and manage.

As the second roller 36 and the third roller 37 can have their positions and orientations set by the first through fourth cylinders 38a through 38d, the bending angle can be set depending on the material, thickness, etc. of the outer panel 12, and the second roller 36 can be changed in position and orientation to perform two roll hemming processes. Therefore, the accuracy with which the bent portion 12a is machined is increased.

With the roll hemming apparatus 10 and the roll hemming method according to the present embodiment, in the first roll hemming process, since the top end 30a of the flange 30 is pressed toward the bent portion 12a by the outer circumferential surface 37a of the third roller 37, bending stresses concentrate in the vicinity of the bent portion 12a. Accordingly, almost no other regions of the outer panel 12 than the bent portion 12a are deformed, so that the outer panel 12 is prevented from being displaced and lifted off. Particularly, almost no inward stresses are developed in the outer panel 12, no pressing mark is left on the lower surface of the outer panel 12 where it is held against the edge of the distal end of the first reduced-diameter portion 34a of the first roller 34.

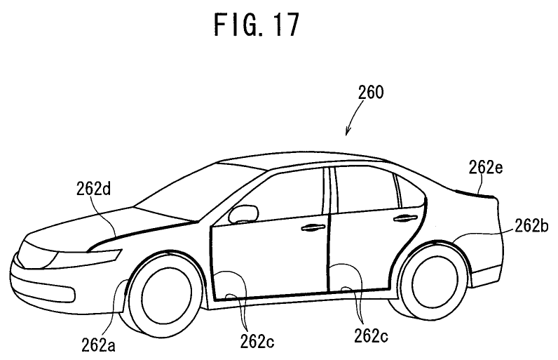

Since the first roller 34 is only required to support the region where stresses are produced, the axial length of the first roller 34 may be reduced. The first roller 34 is thus able to move better depending on the shape of the flange 30 along the direction in which it extends, making the roll hemming apparatus 10 more versatile in application. In other words, the roll hemming apparatus 10 can be used to roll-hem not only the flange 30 which extends straight, but also, e.g., the edge of a vehicle wheel house (see the reference character 262a in FIG. 17). The first roller 34 with the reduced axial length is prevented from interference with a protrusion on the lower surface of the outer panel 12. The roll hemming apparatus 10 is thus applicable to workpieces W of complex shapes and is of increased versatility.

In the machining tool 20, the annular arcuate recess 34b of the first roller 34 is held against an obliquely lower side surface of the bent portion 12a, and the second roller 36 is held against the outer side surface of the flange 30. Consequently, almost no components are present upwardly and inwardly of the workpiece W. The roll hemming apparatus 10 is thus compact and is highly versatile for machining workpieces W of various shapes.

In the above example, the flange 30 is bent by 45° in the first roll hemming process. However, the bent portion 12a may be machined into a shape having a suitable acute angle depending on the material and shape of the workpiece W and the pressure applied by the third roller 37. The first roll hemming process is not limited to a single cycle, but may be performed in a plurality of cycles for bending the bent portion 12a progressively. Specifically, the first roll hemming process may be divided into a plurality of cycles, and the machining angle per cycle may be reduced for increased machining accuracy. The number of cycles may be set in view of the cycle time and also the thickness, material, etc. of the outer panel 12. Similarly, the second roll hemming process may be performed in a plurality of cycles.

The first roll hemming process and the second roll hemming process may be distinguished from each other such that the third roller 37 presses the top end 30a in the first roll hemming process, and the third roller 37 does not press the top end 30a in the second roll hemming process. The second roll hemming process may be performed when the angle by which the bent portion 12a is bent is 45° or greater. After the angle by which the bent portion 12a is bent is 45° or greater, since stresses concentrate on the bent portion 12a even if the third roller 37 does not press the top end 30a, the machining accurately is kept at a desired level.

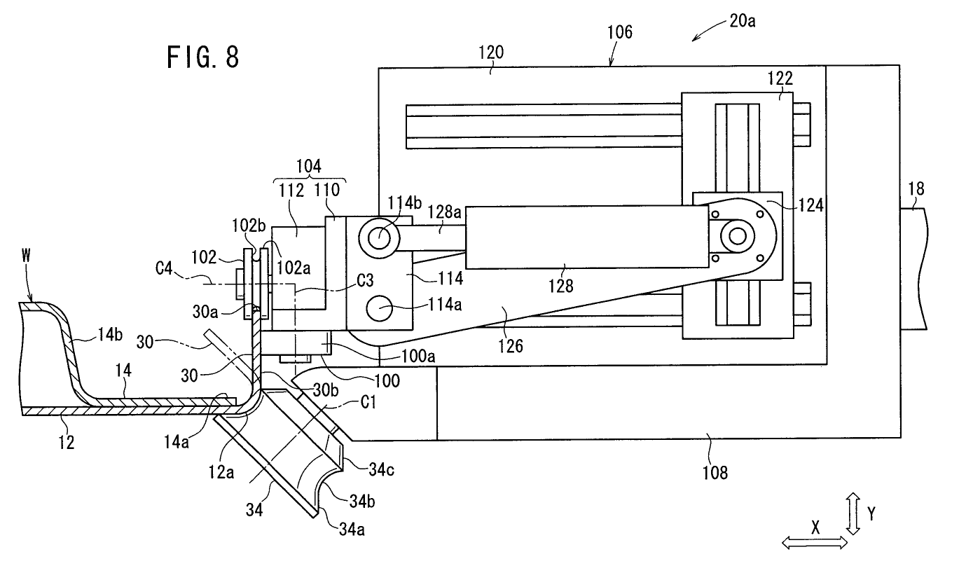

Then, modifications of the machining tool 20 will be described below with reference to FIGS. 8 through 16. Those parts of the modifications which are identical to the machining tool 20 and those parts of the modifications which are identical to each other are denoted by identical reference characters, and will not be described in detail below.

First, a machining tool 20a according to a first modification and a roll hemming method using the machining tool 20a will be described below with reference to FIGS. 8 through 12.

As shown in FIG. 8, the machining tool 20a comprises a roller which is the same as the first roller 34 of the machining tool 20, a second roller 100 corresponding to the second roller 36, a third roller 102 for pressing the top end of the flange 30 toward the bent portion 12a in the first roll hemming process, a support mechanism 104 which supports the second roller 100 and the third roller 102, a position setting unit 106 for changing the position and orientation of the support mechanism 104, and a base 108 serving as a mount on the robot 18 and holding the position setting unit 106.

The base 108 has a lower portion which is identical in shape to the first extension 32a and includes a distal end rotatably supporting the first roller 34 on an obliquely lower surface thereof. When the machining tool 20a is at a reference attitude (an attitude shown in FIG. 8), the second roller 100 has an outer circumferential surface 100a held against the outer side surface 30b of the flange 30. The third roller 102 has a shallow thin annular groove 102b defined in an outer circumferential surface 102a thereof and engaging the top end 30a of the flange 30.

The second roller 100 has an axis C3 extending parallel to the direction in which the flange 30 is erected, and the third roller 102 has an axis C4 extending perpendicular to the axis C3 and oriented inwardly of the panel when at the reference attitude.

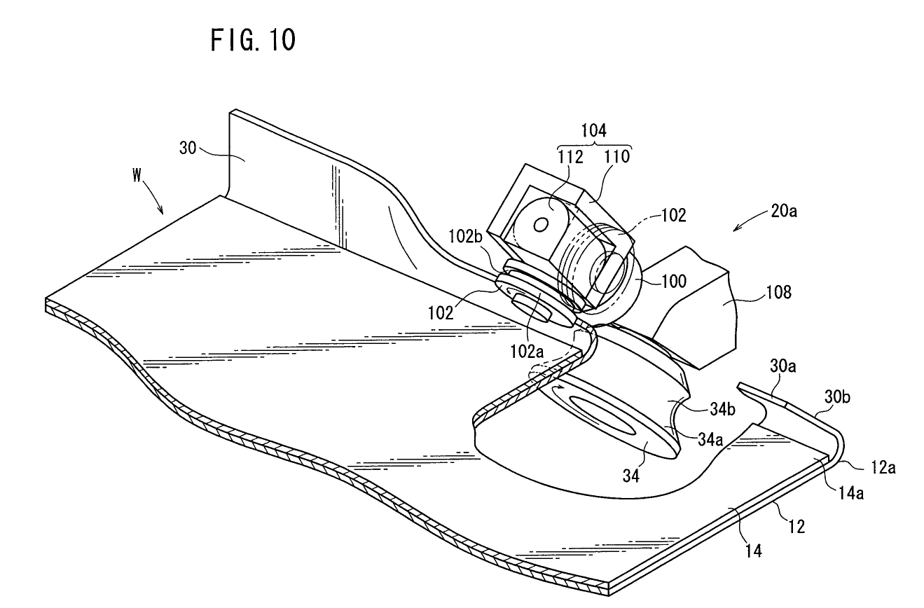

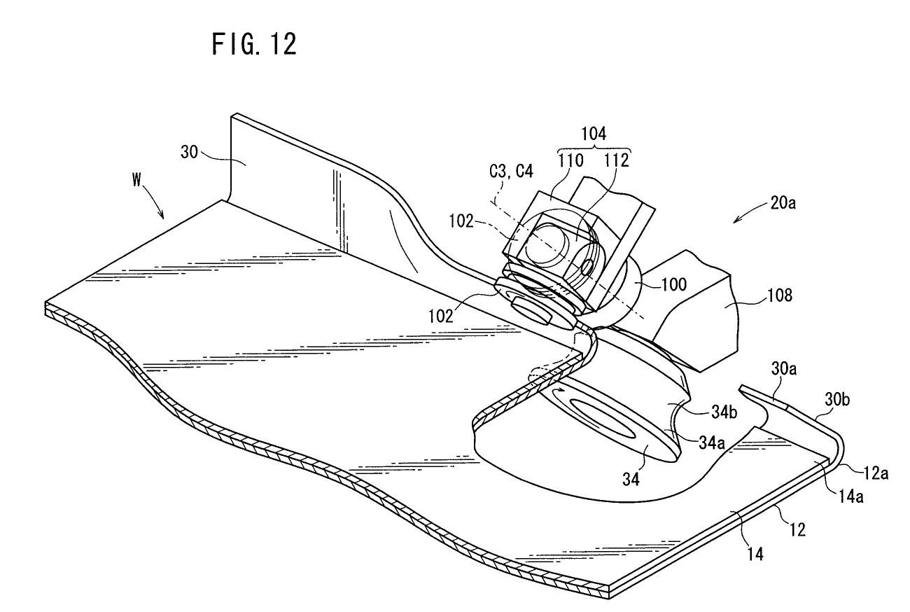

The support mechanism 104 comprises a main support 110 on which the second roller 100 is rotatably supported, an auxiliary support (retracting mechanism) 112 on which the third roller 102 is rotatably supported, and a bracket 114 connected to the position setting unit 106. The main support 110 is substantially L-shaped as viewed in plan (see FIG. 10) and has a lower surface on which the second roller 100 is rotatably supported. The auxiliary support 112 has an end surface on which the third roller 102 is rotatably supported. The auxiliary support 112 is angularly movable by a built-in actuator (not shown) in a range of 90° between stoppers provided by perpendicular walls of the main support 110. The third roller 102 is rotatable about the axis C3 of the second roller 100. When at the reference attitude, the outer circumferential surface 102a of the third roller 102 presses the top end 30a of the flange 30. When rotated by 90° (see FIG. 12), the third roller 102 is retracted away from the flange 30. The auxiliary support 112 rotates about the axis C3 along a circle having a small radius, and the third roller 102 is small in size. Therefore, the actuator for tilting the auxiliary support 112 may be of a small size.

The position setting unit 106 comprises an X table 122 horizontally movable with respect to a vertically extending fixed plate 120, a Y table 124 vertically movable with respect to the X table 122, and a slanted horizontally elongate support plate 126 fixed to the Y table 124. The support plate 126 has a distal end on which there is rotatably supported a rotatable support shaft 114a on a lower portion of the bracket 114. A cylinder 128 has a tube end rotatably supported on the other end of the support plate 126. The cylinder 128 includes a rod 128a whose distal end is connected to a pivot 114b on an upper end of the bracket 114.

The position setting unit 106 thus constructed is capable of changing the position and orientation of the support mechanism 104 in a vertical plane. Specifically, as shown in FIG. 8, the X table 122 is moved to the right and the Y table 124 to a substantially central height, and the rod 128a of the cylinder 128 is retracted, bringing the support mechanism 104 into the reference attitude.

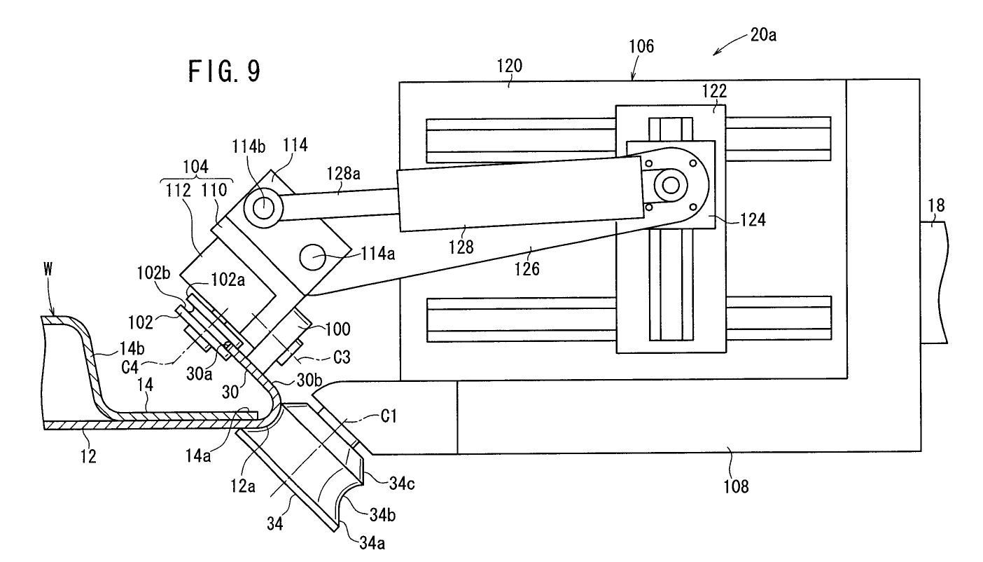

As shown in FIG. 9, the X table 122 is moved to a substantially central position of the fixed plate 120 and the Y table 124 to an elevated position, moving the support mechanism 104 upwardly to the left from the reference attitude. The rod 128a of the cylinder 128 is slightly extended to tilt the support mechanism 104 by 45° about the rotatable support shaft 114a. Now, the flange 30 can be bent by 45° while the outer side surface 30b and top end of the flange 30 are being pressed by the outer circumferential surfaces 100a, 102a of the second roller 100 and the third roller 102 (see FIG. 10). This attitude, therefore, is used in the first roll hemming process.

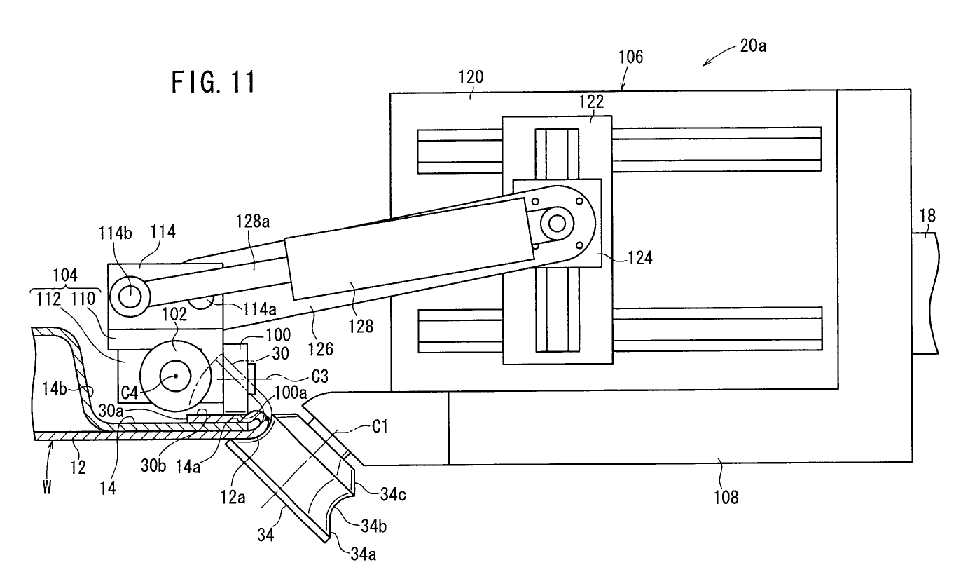

As shown in FIG. 11, the X table 122 is moved to the left and the Y table 124 to the substantially central height, moving the support mechanism 104 leftwards of the reference position. The rod 128a of the cylinder 128 is further extended to tilt the support mechanism 104 by 90° about the rotatable support shaft 114a, so that the flange 30 pressed by the outer circumferential surface 100a of the second roller 100 is bent until it grips the inner panel 14. At this time, the auxiliary support 112 is turned 90° to retract the third roller 102 from the flange 30 for preventing interference with the inner panel 14. This attitude is used in the second roll hemming process.

Since the position setting unit 106 has the X table 122 and the Y table 124 that are movable in perpendicular directions and the cylinder 128 for tilting the support mechanism 104, the movement and the tilting can be controlled independently of each other, resulting in a simple controlling procedure. Specifically, a rotation sensor is provided for detecting a tilt angle of the bracket 114 around the rotatable support shaft 114a, and the cylinder 128 is servo-controlled based on a signal from the rotation sensor to control the orientation of the support mechanism 104. Since the position of the support mechanism 104 is determined based on the bent angle of the flange 30, the coordinates of the rotatable support shaft 114a are identified. By expressing the coordinates as a horizontal X coordinate and a vertical Y coordinate, the positions of the X table 122 and the Y table 124 are specified for positionally controlling the support mechanism 104. On the other hand, the orientation of the support mechanism 104 is independently controlled by the cylinder 128.

A process of roll-hemming the workpiece W with the machining tool 20a thus constructed will be described below. The process of roll-hemming the workpiece W with the machining tool 20a is basically represented by the flowchart shown in FIG. 3, as with the process using the machining tool 20.

First, the workpiece W is fixed to the machining table 16 (step S1). Thereafter, as shown in FIG. 8, the annular arcuate recess 34b fits over the bent portion 12a (step S2). At this time, the machining tool 20a is placed in the reference attitude, and the outer circumferential surface 10a of the second roller 100 is held against the outer side surface 30b of the flange 30, and the outer circumferential surface 102a of the third roller 102 is held against the top end 30a of the flange 30. The top end 30a is reliably held by engagement in the annular groove 102b.

The position setting unit 106 is operated to move the support mechanism 104 to cause the outer circumferential surface 10a of the second roller 100 to press the flange 30 until the flange 30 is bent 45° into the state shown in FIGS. 9 and 10 (step S3).

Then, the robot 18 is actuated to move the machining tool 20a along the flange 30 to perform the first roll hemming process (step S4). At this time, while the outer circumferential surface 102a of the third roller 102 is reliably pressing the top end 30a of the flange 30, the outer circumferential surface 100a of the second roller 100 rolls on and presses the outer side surface 30b of the flange 30 to roll-hem the flange 30. In this case, the pressing force applied from the third roller 102 to the top end 30a can be adjusted by the position setting unit 106.

Since the top end 30a is pressed by the third roller 102, the outer panel 12 is not lifted off the annular arcuate recess 34b of the first roller 34, and the bending stresses developed by the third roller 102 concentrate in a small range near the bent portion 12a. The outer circumferential surface 10a of the second roller 100 is held in line-to-line contact with the outer side surface 30b of the flange 30, and the third roller 102 is held in point-to-point contact (to be exact, in line-to-line contact in the thicknesswise direction) with the top end 30a, while the rollers are rolling and pressing the flange 30. Strictly speaking, both the second roller 100 and the third roller 102 are held in somewhat surface-to-surface contact due to strains. However, since the second roller 100 and the third roller 102 are held in contact with the workpiece in a sufficiently small area, the ability of the first roller 34 and the second roller 100 to move better depending on the shape of the flange 30 along the direction in which it extends, increases, resulting in better versatility of the machining tool. Furthermore, inasmuch as the second roller 100 and the third roller 102 are limited by each other in their axial sliding movement with respect to the outer side surface 30b and the top end 30a, the second roller 100 and the third roller 102 are reliably positioned with respect to the flange 30.

After the first roll hemming process is finished, the auxiliary support 112 is turned 90° to retract the third roller 102 from the flange 30 (see the two-dot-and-dash lines in FIG. 10 and FIG. 11). At this time, since the auxiliary support 112 is rotated about the axis C3 along a circle having a sufficiently small radius, the auxiliary support 112 is kept out of interference with obstacles. As the radius of the circle along which the auxiliary support 112 rotates is small, the response of the auxiliary support 112 is high as it is accelerated and decelerated, so that the auxiliary support 112 can be retracted quickly and simply. These features are provided when the auxiliary support 112 is rotated about the axis C3. However, the axis about which the auxiliary support 112 is rotated is not limited to the axis C3, but the auxiliary support 112 may be rotated about a nearby parallel axis. If the axis of rotation is set in a circular range surrounded by the outer circumference of the second roller 100 as viewed in side elevation, then the radius of the circle along which the auxiliary support 112 rotates may appropriately be set to a sufficiently small value. If the direction in which the auxiliary support 112 rotates is opposite to the direction in which the machining tool 20a travels, then the auxiliary support 112 is kept out of interference with a deformed region 31 (see FIG. 7) even if the deformed region 31 is deformed to a large extent while the machining tool 20a is roll-hemming the flange 30 upon travel on the flange 30.

As indicated by the two-dot-and-dash lines in FIG. 12, the auxiliary support 112 may be a mechanism for rotating the third roller 102 by 90° in a direction to bring the axis C4 thereof into alignment with or parallel to the axis C3 of the second roller 100.

Furthermore, the position setting unit 106 moves the support mechanism 104 to cause the outer circumferential surface 100a of the second roller 100 to further press the flange 30. The outer panel 12, the inner panel 14, and the flange 30 are now gripped by the first roller 34 and the second roller 100 (step S5).

Thereafter, the machining tool 20a performs the second roll hemming process while moving along the flange 30 (step S6). Then, the second roll hemming process is put to an end.

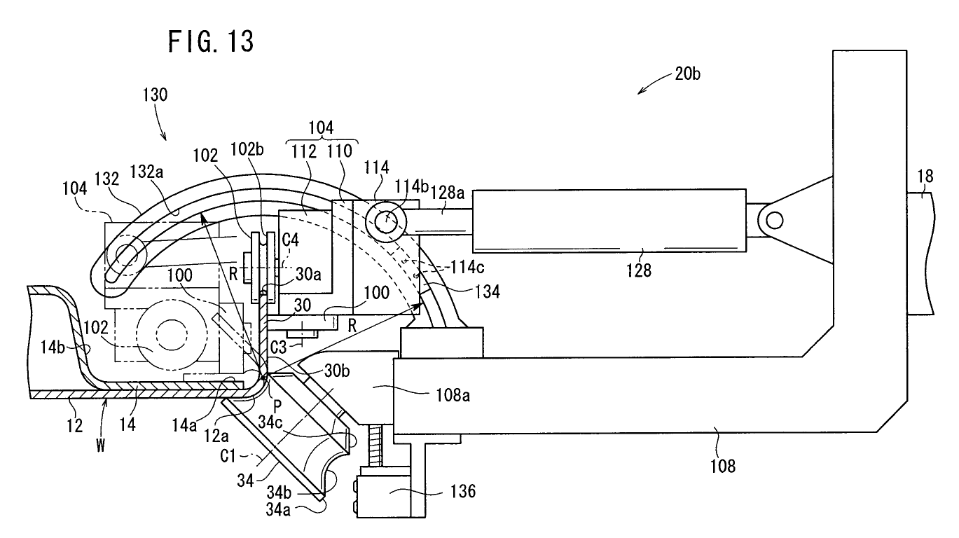

As shown in FIG. 13, a machining tool 20b according to a second modification comprises a first roller 34, a second roller 100, a third roller 102, a support mechanism 104, and a bracket 114 as with the machining tool 20a. The machining tool 20b also has an arcuate slide mechanism 130 corresponding to the position setting unit 106, a slide 108a vertically slidable with respect to the base 108 and supporting the first roller 34 rotatably thereon, and a presser mechanism 136 for pressing the slide 108a toward the arcuate slide mechanism 130.

The arcuate slide mechanism 130 comprises an arcuate support 132 having an arcuate oblong hole 132a with a radius R from a bending base point P, an arcuate slider 134 fitted in the oblong hole 132a, and a cylinder 128. The arcuate support 132 has an end fixed to the upper surface of the distal end of the base 108 and projects inwardly of the workpiece W arcuately by 90° or greater about the bending base point P. The slider 134 is held in slidable engagement with the oblong hole 132a and neatly fitted therein without any gap therebetween. The slider 134 is secured to a portion of the bracket 114 by a bolt 114c. The cylinder 128 has a tube end rotatably supported on a portion of the base 108 and includes a rod 128a whose distal end is connected to the pivot 114b.

The presser mechanism 136 is mounted on a lower surface of the distal end of the base 108 for pressing the slide 108a upwardly through a rotation or screw mechanism to press the flange 30 that is gripped between the first roller 34 and the third roller 102. The distance that the slide 108a is pressed by the presser mechanism 136 may be detected by a suitable means, and the position of the robot 18 may be adjusted depending on the detected distance to keep the first roller 34 and the workpiece W in constant positional relationship to each other.

In the machining tool 20b, when the rod 128a of the cylinder 128 is extended or contracted, the slider 134 slides arcuately along the oblong hole 132a, and the support mechanism 104 moves together with the slider 134 along an arcuate path about the bending base point P. Therefore, when the rod 128a is extended to a medium position, the support mechanism 104 is tilted 45° about the bending base point P to perform the first roll hemming process.

When the rod 128a is sufficiently extended. the support mechanism 104 is tilted 90° about the bending base point P (see the two-dot-and-dash lines in FIG. 13) to perform the second roll hemming process. The machining tool 20b allows the support mechanism 104 to set its orientation and attitude with a single actuator (i.e., the cylinder 128), and hence is simple in mechanical structure and control procedure. Since the presser mechanism 136 operates to apply pressing forces to the flange 30, bending stresses concentrate in the vicinity of the bent portion 12a. For rotating the third roller 102 about the axis C3 by 90° to retract itself away from the flange 30, the machining tool 20b is pulled out from the end of the flange 30 along the direction in which it extends, and the flange 30 is removed from the annular groove 102b. The annular groove 102b may be dispensed with.

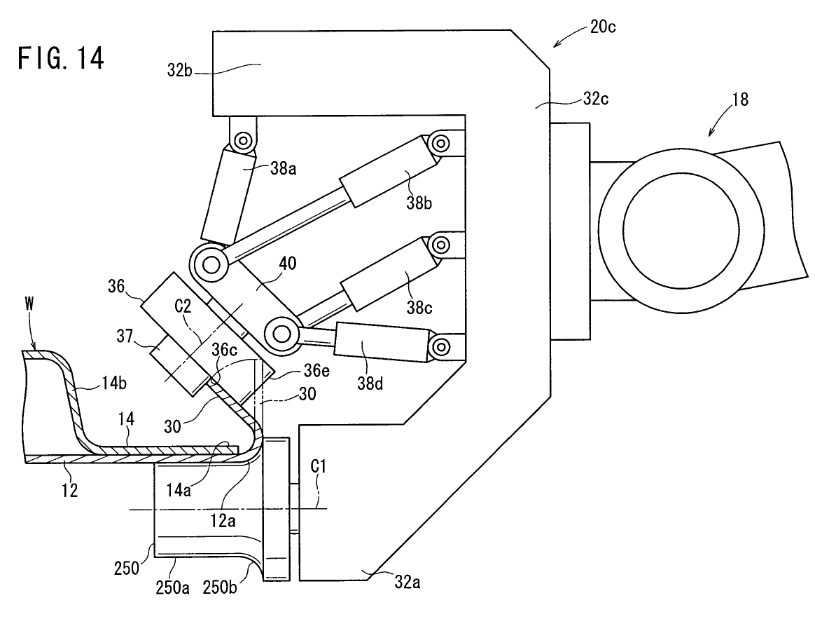

As shown in FIG. 14, a machining tool 20c according to a third modification includes a roller which is the same as the second roller 36 of the machining tool 20 and a first roller 250 which corresponds to the first roller 34.

The first roller 250 is rotatably supported near the distal end of the first extension 32a and extends parallel to the direction in which the first extension 32a extends. The first roller 250 comprises a cylindrical portion 250a with the axis C1 in its center and an annular arcuate portion 250b blending continuously and smoothly into the proximal end of the cylindrical portion 250a. The annular arcuate portion 250b has an arcuate surface having a cross section of about 90°. The arcuate surface has an end contiguous to the end of the cylindrical portion 250a and the other end directed perpendicularly to the axis C1.

When the machining tool 20c with the first roller 250 is used to perform the first roll hemming process in step S4 described above, the bent portion 12a of the outer panel 12 is formed into a round shape while being supported by the annular arcuate portion 250b, as shown in FIG. 14.

For performing the second roll hemming process in step S6 described above, the cylindrical portion 250a has an upper surface held against the lower surface of the outer panel, as shown in FIG. 15. The cylindrical portion 250a and the outer circumferential surface 36e face each other, reliably gripping therebetween the three layers, i.e., the outer panel 12, the edge 14a, and the flange 30, and pressing them into an integral structure. The cylindrical portion 250a has an axial length which is sufficiently greater than the width of the second roller 36, and the second roller 36 can press the flange 30 within the range of the axial length of the cylindrical portion 250a, so that no pressing mark is left on the lower surface of the outer panel 12.

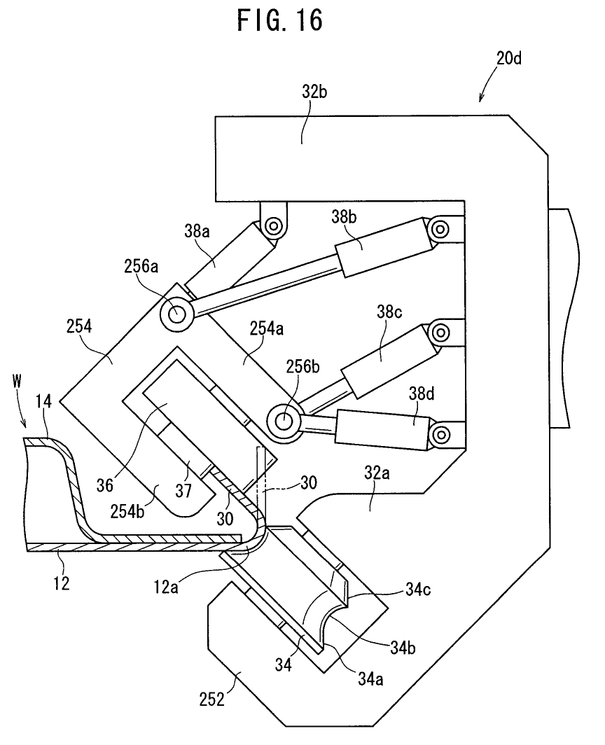

As shown in FIG. 16, a machining tool 20d according to a fourth modification includes has the first roller 34 and the second roller 36 each supported by a dual-end support structure. Specifically, the first roller 34 has an end rotatably supported by the first extension 32a and the other end rotatably supported by an auxiliary extension 252 which coordinates with the first extension 32a in making up a U shape.

The second roller 36 has its ends rotatably supported by respective two extensions 254a, 254b of a U-shaped bearing member 254. The bearing member 254 has a first support shaft 256a on which the rods of the first cylinder 38a and the second cylinder 38b are rotatably supported, and a second support shaft 256b on which the rods of the third cylinder 38c and the fourth cylinder 38d are rotatably supported. The first roller 34 and the second roller 36 with their both ends being thus supported allow the roll hemming process to be performed more stably.

The machining tools 20a through 20d according to the first through fourth modifications operate in the same manner as the machining tool 20 in that the third roller 37 or 102 operates to cause bending stresses to concentrate in the vicinity of the bent portion 12a and are advantageous in that they prevent the flange 30 to be lifted off and displaced. Therefore, the machining tools 20a through 20d basically operate in the same manner as the machining tool 20.

Locations to which the roll hemming method and the roll hemming apparatus 10 according to the present embodiments are applied to perform the roll hemming process include, for example, as shown in FIG. 17, the front wheel house edge 262a, a rear wheel house edge 262b, a door edge 262c, a hood edge 262d, and a trunk edge 262e of a motor vehicle 260.

In the above description, the machining table 16 and the robot 18 operate synchronously in coordination to perform the roll hemming process. However, since the machining tools 20, 20a through 20d may move relatively to the bent portion 12a in the roll hemming process, either the machining table 16 or the robot 18 may be controlled to operate.

Two machining tools 20 may be juxtaposed, and one of the machining tools 20 which is positioned ahead in the moving direction may have the second roller 36 set to the position shown in FIG. 2 and the other machining tool 20 may have the second roller 36 set to the position shown in FIG. 6, for thereby continuously performing the first and second roll hemming processes in steps S4, S6.

In the above description, the bent portion 12a of the outer panel 12 grips the inner panel 14 to produce an integral structure. Alternatively, the roll hemming method and the roll hemming apparatus 10 may be applied to a process in which the inner panel 14 is dispensed with and only the outer panel 12 is bent over, and a process involving a plurality of inner panels 14.

1. A roll hemming method of bending a flange as an erected edge of a panel, inwardly of the panel, comprising:
supporting an outer side of a bent portion of said flange with a first roller;
pressing inwardly said flange near said bent portion supported by said first roller with a second roller; and
bending said flange inwardly of said panel while moving said first roller and said second roller together along said bent portion.

2. The roll hemming method according to claim 1, comprising:
a first step of pressing said flange with an end surface of said second roller to bend said flange until said bent portion provides an acute angle; and
a second step of changing the orientation and position of said second roller and further bending said flange with an outer circumferential surface of said second roller.

3. The roll hemming method according to claim 2, wherein in said first step, a third roller coaxial with said second roller and smaller in diameter than said second roller is used, and a top end of said flange is pressed toward said bent portion with an outer circumferential surface of said third roller.

4. A roll hemming method of bending a flange as an erected edge of a panel, inwardly of the panel, comprising:
supporting an outer side of a bent portion of said flange with a first roller;
pressing an outer side surface of said flange with a second roller;
pressing a top end of said flange toward said bent portion with a third roller; and
bending said flange inwardly of said panel to provide an acute angle while rotating said first roller, said second roller, and said third roller.

5. The roll hemming method according to claim 4, wherein the outer side surface of said flange is pressed with an outer circumferential surface of said second roller, and the top end of said flange is pressed toward said bent portion with an outer circumferential surface of said third roller.

6. A roll hemming apparatus for bending a flange as an erected edge of a panel, inwardly of the panel, comprising:
a first roller for supporting an outer side of a bent portion of said flange;
a second roller for pressing inwardly a portion of said flange near said bent portion supported by said first roller; and
a moving unit for moving said first roller and said second roller together along said bent portion.

7. The roll hemming apparatus according to claim 6, comprising a third roller for pressing a top end of said flange toward said bent portion in at least one step.

8. The roll hemming apparatus according to claim 7, comprising a retracting mechanism for changing the orientation of said third roller about an axis of said second roller or an axis parallel to said axis.
